(19) United States
(12) Patent Application Publication
(10) Pub. No.: US 2001/0048955 A1
(43) Pub. Date: Dec. 6, 2001

(54) Method of feeding an animal a balanced meal

(76) Inventors: Gary A. Foreman, Indianapolis, IN (US); Cathy E. Foreman, Indianapolis, IN (US)

Correspondence Address: Michael C. Bartol, Attorney at Law, 700 Illinois Building, 17 West Market Street, Indianapolis, IN, 46204, US

(21) Appl. No.: 09/789,178

(22) Filed: Feb. 20, 2001

Related U.S. Application Data
(60) Provisional application No. 60/207,305, filed on May 30, 2000.

(51) Int. Cl. A23L 1/00

(52) U.S. Cl. 426/2

(57) ABSTRACT

A method for feeding a pet a balanced meal or supplement. For a dog, the meal includes a main course having a high protein content, a side dish having a high carbohydrate content and a dog treat preferably in the traditional shape of a bone or biscuit which the dog has been preconditioned to perceive as a reward. The meal is provided in a tray having a removable cover, the tray being divided into separate compartments in which the main course, side dish and treat are placed. According to this inventive method, the dog receives a well-balanced and enjoyable meal or supplement.

### CROSS REFERENCE TO RELATED APPLICATIONS

This application claims priority from U.S. Provisional Patent application Ser. No. 60/207,305, filed May 30, 2000.

### FIELD OF THE INVENTION

The present invention relates to a method for feeding an animal. More particularly, the present invention relates to providing an animal such as a dog an enjoyable, nutritious and multi-component meal or supplement.

### BACKGROUND OF THE INVENTION

Commercial dry dog foods were introduced in the United States during the late 1890's in the form of baked biscuits made with blended grains, vegetables and meat. Many early pet foods were collectively labeled “dog and cat food diets” and little was known about the individual nutrient requirements of dogs and cats. However, as animal nutritionists began to study the nutritional needs of dogs and cats, certain unique nutrient requirements were established for each species. The nutrient requirements for dogs and cats are now well-known, and most commercially available pet foods easily meet these nutritional requirements.

Until recently, an issue which has received far less attention than pet nutrition is the palatability and enjoyment of pet foods. However, pet owners are increasingly taking a greater interest in the satisfaction their pets derive from eating. Pets are increasingly being perceived by their owners as “one of the family,” rather than merely “chattel” or personal property. In this connection, some pet foods are now designed with palatability or enjoyment of the pet as their distinguishing feature.

One known approach for enhancing palatability involves a product having “kibbles” with different sizes and shapes and carrying various flavor claims. They appeal to pet owners interested in indulging their pet and providing better variety. While they may appeal to the pets' owners, it has been found that these products are only marginally more desirable for the pets. The pets do not appreciate the different size and flavor kibbles and quickly grow tired of receiving the same bowl filled with the same food, day after day. As with many prior art approaches to palatability of pet food, this approach was designed around and limited by the deep-seated teachings and constraints imposed by traditional pet food packaging, namely, that the packaging must comprise a single, cost-effective bag, can or box. Under the conventional wisdom, the additional cost of producing more elaborate packaging was simply not thought justified.

Another prior art approach to pet satisfaction is disclosed in U.S. Pat. No. 5,925,390 to Kornacki. The disclosed serving system provides a container having three food containing compartments. A lid having perforations along its periphery seals the container. Each compartment has a different type/flavor of food. Indiana of each particular food item is marked in the corresponding compartments so that after a particular food item has been consumed by the cat, the food item can be identified by the indicia remaining in the compartments. In this manner, the cat's owner may ascertain which of the differently flavored cat food products are most desirable to the cat. The invention essentially teaches feeding the cat the single food item that has been ascertained as that which is most liked. Unfortunately, while this approach may be initially successful, many pets will inevitably grow tired of being fed the same food item meal after meal, day after day.

Other approaches to providing more enjoyable food items for pets include pet bakeries, hand-made treats, attractive packaging designed to entice the pet (and its owner), custom “feeding tables” and foods having “all natural” or “holistic” ingredients, to name just a few. Other approaches include ice cream packaged in individual containers, separate gravies to apply to regular pet foods to enhance nutrition and palatability, “power bars,” and electrolytic drinks akin to Gatorade®. However, the deep-seated packaging constraints that have survived for over a century in the pet food industry continue to effect the way in which new pet food items are conceived and developed. It is desirable to provide a meal or supplemental treat for a pet that is not only satisfying to the pet, but also nutritious and well-balanced.

### SUMMARY OF THE INVENTION

The present invention provides a balanced meal or treat for a pet served in a tray having at least two separate compartments which contain two different food items. The present invention totally changes the conventional way of feeding a pet. Instead of focusing on supplying the pet with one food item and enhancing the single food item's palatability, as is known in the art, the present invention provides two or more different food items that are separated from one another. The pet thereby derives satisfaction from its meal like people do, from the variety of taste, smell and texture of the multiple food items from different food groups consumed in a single feeding.

In one form thereof, the present invention provides a method of feeding an animal. The method comprises providing a main course and a treat. A tray is provided having at least two separate compartments. The main course is placed into a first of the compartments and the treat is placed into a second of the compartments. The tray is presented to the animal and the animal consumes the contents of the compartments.

In a preferred form, the method further comprises placing the tray into an oven before feeding the animal. In a further preferred form, a sticking tab is provided on the bottom of the tray and the tray is adhesively adhered to the floor before allowing the pet to eat. In another preferred form of the method just described, the method further comprises providing a side dish, the tray has three compartments, and the side dish is placed into the third compartment.

In another form thereof, the present invention provides a method of feeding a dog. The method comprises the steps of selecting a main course and a dog treat, providing a tray having at least two separate compartments, and placing some of the main course into a first of the compartments and placing some of side dish into a second of the compartments. The tray is then sealed with a removable cover. To serve the meal to the dog, the cover is removed and the tray presented to the dog. The dog then consumes at least a portion of the main course and dog treat.

In a preferred form of the method just described, the tray includes a third separate compartment, the method further including selecting a side dish and placing a desired amount of the side dish into the third compartment, the dog consuming at least a portion of the side dish. In a further preferred form, the side dish has a weight ratio of fiber to protein of at least 5 to 1.

One advantage of the present invention is that it provides two or more different food items separated from one another. In this manner, the pet achieves a more enjoyable meal by virtue of its variety. One line of prior art known to applicant focuses on enhancing palatability of the dog's main meal. A second line of prior art of which applicant is aware focuses on providing a more enjoyable “treat.” The present invention totally rethinks the traditional packaging constraints and combines an enjoyable main course, a treat, and optionally a side dish—all in a single feeding. With the present invention, the pet receives his “treat” along with the main course, the treat being somewhat analogous to a “dessert” consumed by people.

In this connection, the present invention has not been limited by the “single package” design limitation and way of thinking imposed by the teachings of the prior art. Ignoring these deep-seated packaging constraints made possible a multi-course meal wherein the pet may enjoy different food items in a single meal, like people do.

Another advantage of the present invention is that it provides a balanced meal for a pet without undesirably having to “cram” all of the individual nutritional constituents and vitamins into a single food item, as is taught by the conventional wisdom. Instead, the present invention provides a balanced meal through a variety of different and separate food items. This creates flexibility in the possible arrangement and selection of food items.

Yet another advantage of the present invention is that it may serve as a supplement, snack, or treat. Instead of the conventional dog or cat treat that is made up of a single component, the present invention can provide a multi-component treat or snack, thereby enhancing the enjoyment derived by the pet.

Still another advantage of the present invention is its ease of preparation. Meals made in accordance with the present invention can simply be removed from the refrigerator or freezer, placed in a microwave oven, and then served to the pet.

Yet another advantage of the present invention is that the tray doubles as a feeding container, thereby obviating the pet's bowl. This is especially advantageous when the pet travels with its owners. The present invention avoids the inconvenience of measuring an amount of traditional pet food from a bag and repackaging the food for the trip. Instead, with the present invention, the meal can be thawed, placed in a cooler, and conveniently served during the trip by removing the plastic film. No extra bowls or can openers are required with the present invention.

Yet another advantage of the present invention is that the meals are individually packaged so that freshness is not compromised. By contrast, many conventional pet foods are packaged in large bags, and once opened, the food gradually becomes stale.

Still another advantage of the present invention is that it gives the pet's owner a sense of treating the pet like “one of the family.” Like a meal for people, the present invention provides a meal for a pet with more than one course.

### BRIEF DESCRIPTION OF DRAWINGS

The above-mentioned and other advantages of the present invention, and the manner of obtaining them, will become more apparent and the invention itself will be better understood by reference to the following description of the embodiments of the invention taken in conjunction with the accompanying drawings, wherein:

FIG. 1 is a perspective view of a tray including a pet meal in accordance with the present invention, illustrating the flexible cover partially peeled away;

FIG. 2 is a perspective view of a pet meal in accordance with the present invention, illustrating the preparation of the meal in a microwave oven;

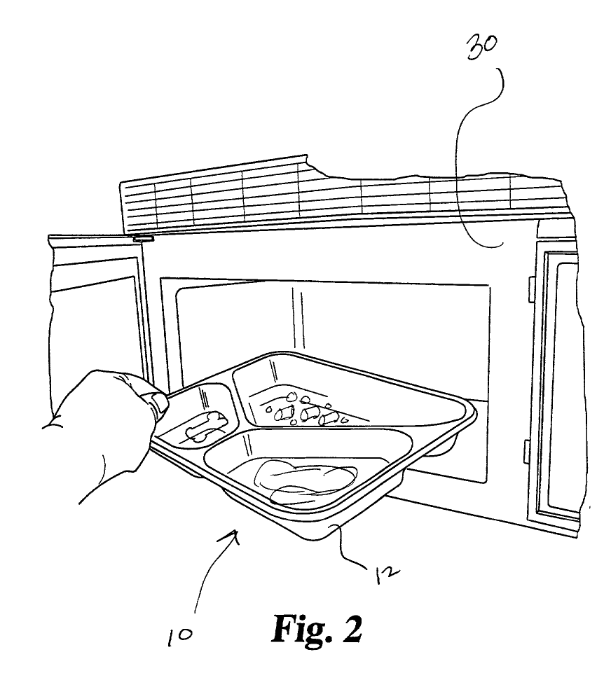

FIG. 3 is a perspective view which illustrates a feature of the present invention which prevents pet trays in accordance with the present invention from sliding along the floor while the pet is eating; and

FIG. 4 is a perspective view illustrating a dog eating a meal made in acordance with the present invention.

Corresponding reference characters indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

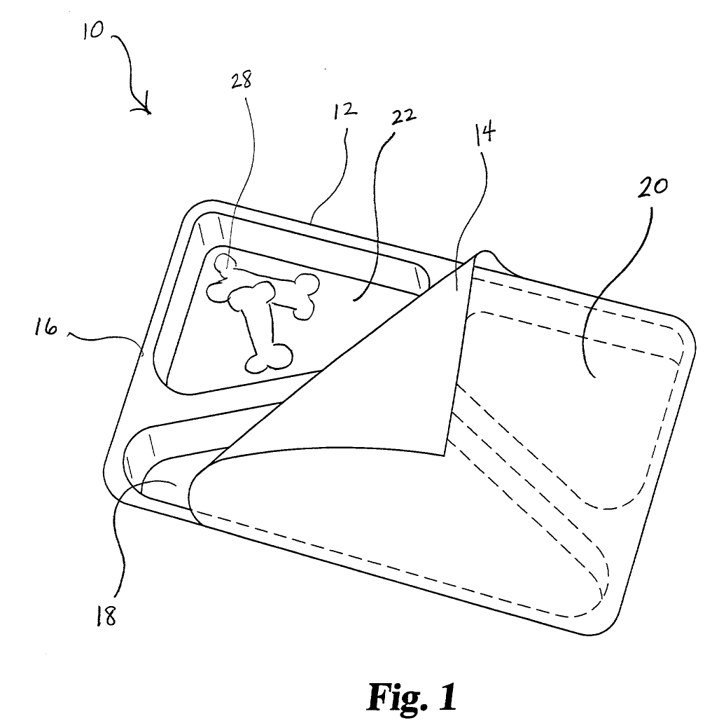

Referring now to the FIGS., particularly FIG. 1, meal 10 for a dog is packaged in a tray 12 having a cover 14 removably adhered thereto. Tray 12 can be formed of polyethylene terephthalate (PETE) or other suitable plastic material as is known in the art. One tray 12 suitable for use with the present invention is commercially available from Green-Tek Company, Edgerton, Wis., under product identifier #2015 CPET. This is a three compartment tray having overall dimensions of 9 inches×7 inches×1.25 inches. Many variations for tray 12 are possible, the critical characteristic being that tray 12 must be able to withstand a temperature range of −20 to 300 degrees Fahrenheit without degradation or deformation.

Cover 14 is preferably formed from sheet material such as polyurethane, polyethylene or the like, which is suitable for receiving printing and labeling, and which is suitable for maintaining freshness of the contents of tray 12. One suitable cover 14 is a 100 gage film, product code #OL2T, available from Oliver Products, Grand Rapids, Mich. Cover 14 is preferably heat-sealed by conventional means to flange 16 which defines the periphery of tray 12. The heat seal creates adhesion of cover 14 to tray 12 such that cover 14 seals the contents of the tray, yet the cover can be easily peeled from the tray to expose the contents.

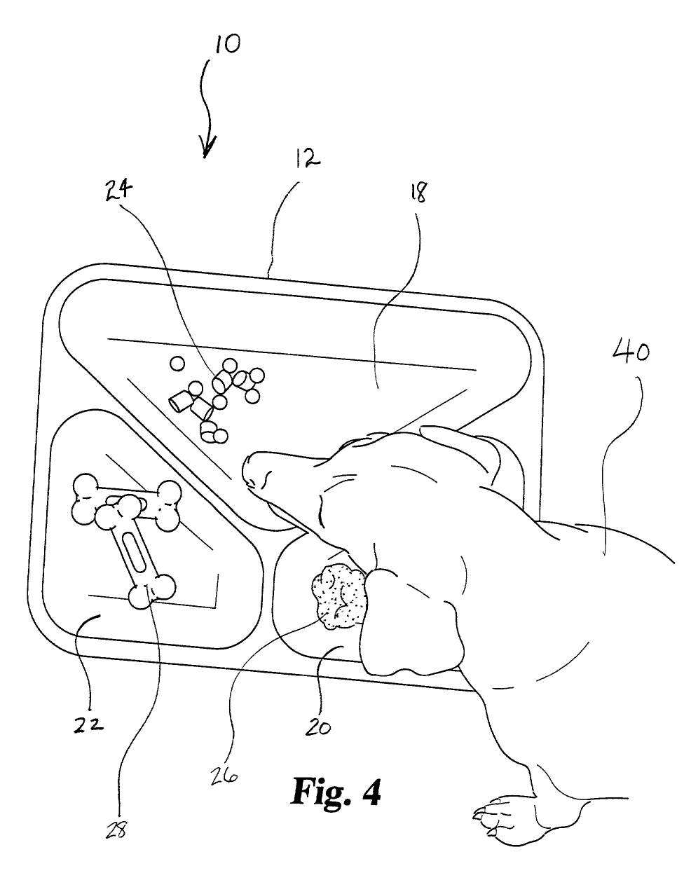

As shown in the FIGS., tray 12 is formed such that it is divided into three compartments, 18, 20 and 22. As shown particularly in FIG. 4, compartment 18 includes an “entree,” or main course 24, compartment 20 includes a side dish 26, and compartment 22 includes a treat 28. For purposes of this specification, the term “balanced” applies to the variety of food items packaged in tray 12 and refers to the enhanced palatability and enjoyment derived by the pet from such variety. For purposes of this specification, then, the term “balanced” should not be construed as implying that a meal 12 made in accordance with the present invention will meet any defined nutritional requirements set forth by any independent or governmental agencies promulgating such requirements.

For purposes of this specification, the main course 24 is defined as follows. First, main course 24 is characterized in that it includes a substantial amount of a high protein component such as beef, lamb, veal, chicken, turkey, fish or the like. Such high protein component is typically the major constituent of main course 24. A variety of food items would be suitable for the main course. Generally, the item selected for the main course should have a high protein and fat content, somewhat analogous to the “meat” course of a traditional American or European meal for people.

More specifically, for purposes of this specification, suitable food items for the main course have a protein content of 5% to 60%, a fat content of 1% to 50% and a carbohydrate or fiber content of 1% to 60%. These percentages are based upon the total weight of the main course, including water content. For purposes of the percentages listed in this specification, the term “fiber” is used interchangeably with “carbohydrate.” Several commercially available products would be suitable for main course 24.

One such product is Mighty Dog “Beef in Gravy,” 5.5 oz., available from Friskies Petcare Co., Inc., Glendale, Calif. The Mighty Dog product contains a minimum of 9% protein, a minimum of 3% fat and a maximum of 1.5% fiber. Another suitable main course is “Beef,” 5.5 oz., available from Award Gourmet Pacific Coast Distribution, Inc. Phoenix, Ariz. The Award Gourmet product contains a minimum of 10% protein, a minimum of 6% fat and a maximum of 1.0% fiber or carbohydrate. Another suitable main course is “Chopped Beef,” 13.2 oz., available from Pedigree (Waltham) by Kal Kan Foods, Inc. Vernon Calif. The Pedigree product contains a minimum of 8% protein, a minimum of 6% fat and a maximum of 1.5% fiber or carbohydrate. These percentages are based upon total weight of the main course. The remainder of the main course is substantially water. Other suitable main courses include a desired amount of canned beef stew or canned chicken and dumplings, both of which are available under the “Hearthstone Classics” brand name. The preferred portion size of the Hearthstone main courses is currently between 2.5 to 5 ounces, although smaller or larger portions are certainly possible and within the scope of this disclosure.

The inventors of the present invention have also conceived a custom made main course 28, referred to herein as “Turkey Mutthatan.” About 1.5 oz. of ground turkey, such as that available under the “Louis Rich” brand name, Madison, Wis, is placed into boiling water until thoroughly cooked. The water is then drained and the turkey is set aside to cool for about 10 minutes. Next, approximately ½slice of white bread, such as that commercially available under the brand name “Wonderbread,” is placed into compartment 18 of tray 12 and the cooled ground turkey is spooned over it. Next, approximately 1.0 oz. of roasted turkey gravy, such as that available under the Hearthstone Brand is drizzled over the turkey and bread.

For purposes of this specification, side dish 26 is defined as follows. In contrast to main course 24, side dish 26 includes little, if any, of a high protein component, as that term is used above. Instead, side dish 26 is characterized in that the major constituent thereof is a high carbohydrate or fiber component such as rice, potatoes, corn meal, wheat, and the like. Two suitable side dishes are carrots and rice. When choosing carrots as side dish 26, about ½oz. of canned, sliced carrots, such as those commercially available under the “Gordon Food Service” brand, or a comparable generic brand, are drained and placed into compartment 20. The carrots may be smashed or further cut into bite-sized pieces. A pinch of brewer's yeast such as that commercially available under “Pet Organics” brand name from Baxter Environmental Products, Inc. Orange, Calif. is added to the carrots. If rice is chosen as side dish 26, about 0.75 oz. of a commercially available product, such as Uncle Ben's brown rice, is cooked according to the instructions on the package and then placed into compartment 20 of tray 12. A pinch of brewer's yeast such as that commercially available under “Pet Organics Brand” is added to the rice.

It is to be understood that the preparation instructions disclosed herein will readily be adapted by one of ordinary skill in the art to large-scale production.

For purposes of this specification, side dish 26 has a carbohydrate or fiber to protein ratio of at least 5 to 1, more preferably at least 7 to 1. One significant difference between the side dish and the main course in accordance with the present invention is that the main course always includes a substantial amount of the “high protein” or “meat” component as described above whereas the side dish contains little or none of such high protein component.

For purposes of this specification, treat 28 is defined as follows. First, treat 28 is characterized in that it preferably comprises a bone or biscuit shape as shown in FIG. 4. Secondly, an aspect of the method in accordance with the present invention is that the dog has been “preconditioned” by its owners to respond to the general appearance of treat 28. That is, most commercially available dog treats are shaped like a bone or biscuit and are fed to the dog as a “reward” for performing a specific activity, such as sitting, rolling over and obeying similar commands. Thus, the dog becomes preconditioned to perceive the “bone-shaped” treat as a reward for successfully obeying its owner. The taste of the treat often becomes secondary to the satisfaction the dog receives from pleasing its owner.

Thus, without wishing to be tied to any specific theory, it is believed that for a dog meal prepared in accordance with the present invention, the dog derives satisfaction from the meal, in part, from its previous conditioning with treats similar to treat 28 packaged in compartment 22. That is, the dog perceives meal 10 served in tray 12 as a reward because it has been preconditioned to do so. Thus, in accordance with the method of the present invention, a treat that evokes from the dog the type of pre-conditioned response just noted would suffice for treat 28.

One specific example of a suitable treat for use in accordance with the method of the present invention is “Natural Meaties with Real Liver Flavor,” liver flavor, round shaped, 8.3 oz., available from Old Mother Hubbard, Lowell, Mass. Another example is “Oral hygiene biscuits” 6 oz., bone-shaped, available from Smart Snacks from Chicago, Ill. Another example is “Special T's,” Real Beef, 10oz., T-bone shaped, available from O1' Roy Brand by Wal Mart Stores, Bentonville, Ark. Yet another suitable dog treat 28 is “P-Nuttier Basted Dog Biscuits” available under the “Old Mother Hubbard” brand, Lowell, Mass. “Jerky Plus with Real Beef and Vegetables,” available form Hill's Science Diet, Topeka, Kans., is yet another treat suitable for treat 28.

While not believed entirely necessary to the success of treat 28 in accordance with the present invention, it is preferable that treat 28 include an additive to enhance flavor and/or smell. Such additives may include, among other things, mint, charcoal flavoring, peanut butter, dried parsley flakes and sweet potato powder. These additives are not typically found in main course 24.

A typical dog treat in accordance with the present invention would have 5% to 50% fat, 20% to 85% carbohydrate or fiber, and 5% to 50% protein. In preparing meal 10, treat 28 is placed into compartment 22.

In accordance with the method of the present invention for use with a dog, one must select suitable food items for main course 24, treat 28 and, optionally, side dish 26. The food items selected must meet the defined criteria for each as set forth above. Next, a tray 12 must be provided that includes a sufficient number of separate compartments for each of the different food items. The presently preferred embodiment for a dog includes three separate compartments 20, 22 and 24 as shown in the FIGS. However, it is to be understood that certain embodiments incorporating the present invention may include only two compartments, for example, when used to feed a cat, as discussed below. Further, while not the preferred embodiment, side dish 26 can be omitted from the dog meal. In such cases, the dog meal would include only main course 24 and treat 28 and a tray having only two separate compartments would suffice. It is to be understood that one of ordinary skill may adapt the principles of the present invention for a tray with four or more compartments and different dishes. For example, an alternate meal for large dogs may involve a dog meal having two different side dishes, a main course and a treat (dessert). One of ordinary skill in the art would readily appreciate that these types of modifications fall within the scope and teachings of this disclosure.

After selecting suitable food items that meet the defined criteria for each, a desired amount of each food item is packaged into the separate compartments of tray 12. With reference to the FIGS., an amount of main course 24 is placed into compartment 18, which is the biggest compartment. An amount of side dish 26 is placed into compartment 20 and one or more treats 28 are placed into compartment 22. While it is to be understood that the amount of each respective food item can vary widely, depending on the size of dog or the role meal 10 plays in the dog's overall diet, as well as other factors, the weights of main course 24, side dish 26 and treats 28 in the presently preferred embodiment are 3 ounces, 0.5 ounces, and 0.5 ounces, respectively. Preferably, main course 26 comprises 50% to 80% by weight of meal 10, side dish 26 comprises 5% to 25% of meal 10 and treat 28 comprises 5% to 25% of meal 10.

Next, tray 12 is sealed with cover 14, which is preferably accomplished by conventional heat sealing, as is known in the art. Specifically, a heat-sealing iron is heated to about 250° F. and pressed to tray 12 for about 1-2 seconds. Alternatively, a suitable adhesive could be used to releasably adhere cover 14 to tray 12. Conveniently, cover 14 includes markings and instructions (not shown) for preparing meal 10. After tray 12 is sealed, a plurality of trays 12 can be boxed and stored. Depending on the particular food items selected and whether the storage requirements be long or short term, meal 10 can either be refrigerated or frozen to preserve the contents during shipping and storage, until meal 10 is ready to be served to the dog.

To prepare meal 10, the dog's owner removes meal 10 from the refrigerator or freezer and peels plastic film or cover 14 from tray 12, as indicated in FIG. 1. If cover 14 is properly adhered to tray 12, it peels therefrom easily, without ripping or sticking to the extent that removal becomes difficult. After cover 14 is removed, tray 12 is placed in microwave oven 30 and the oven set on high for about two minutes. It is to be understood that the power output of microwave ovens varies, and that this time may be varied accordingly. Alternatively, meal 10 may be heated in a conventional oven, which consists of placing the tray into a 250° F. oven and heating for about 20 minutes. As an additional alternative, the tray 12 may be left in the refrigerator and served cold. If heated, after removing from the oven, tray 12 should stand for a few minutes until it becomes “cool to the touch.”

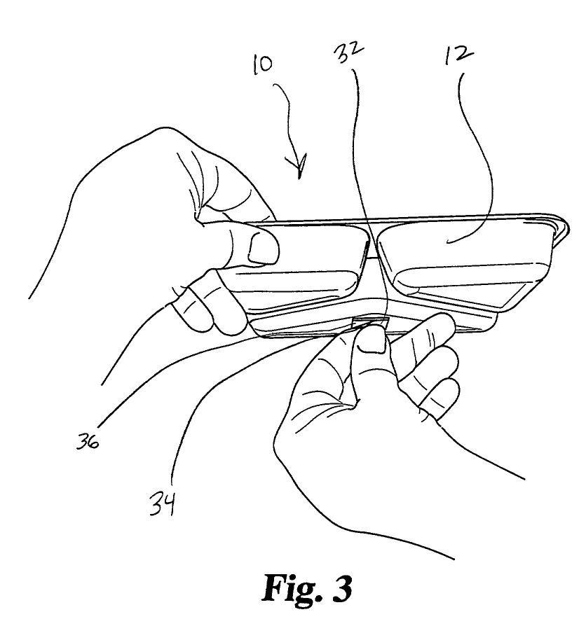

With reference to FIG. 3, tray 12 includes stick tab 32 on the bottom thereof. Stick tab 32 has a removable cover 34 which is peeled away to expose an adhesive 36. A suitable stick tab for the present invention is available from 3M Corporation, St. Paul, Minn. under product number C4016. Tray 12 is then placed against the floor in a location where the dog is to be served and the adhesive causes the tray to stick to the floor and stay in place while dog 40 eats meal 10 as shown in FIG. 4. Conveniently, after the dog has consumed the meal, the entire tray can be discarded.

It has been found experimentally that a dog meal prepared and served in accordance with the present invention provides greater satisfaction and enjoyment for the animal than prior art dog food. For example, dogs fed meals 12 made in accordance with the present invention wagged their tail when being fed, an accepted signal that a dog is happy. Further, the dogs barked, wagged their tales and attempted to eat meal 12 even before it was placed on the floor. In another experiment, a dog preferred a meal 12 made in accordance with the present invention when offered in a side-by-side choice with the dog's “regular” dog food. Finally, the dog growled when the meal embodying the present invention was attempted to be moved or taken away.

Although the presently preferred embodiment has been described with reference to a meal for dogs, it is to be understood that the method of the present invention can also be adapted to a cat. It is presently contemplated that a meal for a cat in accordance with the present invention would include a main course and a treat in a tray having two compartments.

For purposes of this specification, a suitable main course for a cat would meet the same definition as the main course described for a dog hereinabove. The main course for a cat meal would include a substantial amount of a high protein component such as beef, lamb, veal, chicken, turkey, fish or the like. A variety of food items would be suitable for the main course. One suitable main course for a cat meal in accordance with the present invention is “Tender Beef in Meaty Juices,” Sheba (Waltham) by Kal Kan Foods, Inc., Vernon Calif.

For purposes of this specification, the definition of a cat treat would differ from that of the dog treat given hereinabove, in that the cat would not typically be preconditioned to perceive the cat treat as a reward. Specifically, the cat treat is characterized in that its flavor and smell are enhanced as compared with the main course. For example, one suitable cat treat is “Pounce,” by Heinz Pet Products, Pittsburgh, Pa. Another suitable cat treat is “Chicken Meal and Rice Formula” from Optimum Nature's Recipe Pet Foods, Corona, Calif. “Cat nip,” which is an herb, can be provided with the cat treat to further enhance its smell and flavor and thus desirability for the cat.

While a preferred embodiment and method incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of feeding an animal, comprising:
a) providing a main course and a treat;
b) providing a tray having at least two separate compartments;
c) placing the main course into a first of the compartments and placing the treat into a second of the compartments;
d) presenting the tray to the animal; and
e) the animal consuming the contents of the compartments.

2. The method of claim 1, further comprising sealing the tray with a removable cover after step c) and removing the cover before step d).

3. The method of claim 1, further comprising placing the tray into an oven before step d).

4. The method of claim 3, further comprising waiting a sufficient period of time for cooling after removing the tray from the oven before performing step d).

5. The method of claim 1, further comprising discarding the tray after step e).

6. The method of claim 1, further comprising adhesively adhering the tray to a surface during step d).

7. The method of claim 1, wherein step a) further comprises providing a side dish, the tray has three compartments, and step c) further comprises placing the side dish into the third compartment.

8. The method of claim 7, wherein the treat comprises a dog treat and the animal comprises a dog.

9. The method of claim 7, wherein the side dish has a fiber to protein weight ratio of at least 5 to 1.

10. The method of claim 7, wherein said main course comprises at least 30% by weight of a high protein component.

11. A method of feeding a dog, comprising:
selecting a main course;
selecting a treat;
providing a tray having at least two separate compartments;
placing some of the main course into a first of the compartments and placing some of treat into a second of the compartments;
sealing the tray with a removable cover;
removing the cover;
presenting the tray to the dog; and
the dog consuming at least a portion of the main course and treat.

12. The method of claim 11, wherein the tray includes a third separate compartment, the method further including selecting a side dish and placing a desired amount of the side dish into the third compartment, the dog consuming at least a portion of the side dish.

13. The method of claim 12, wherein the side dish has a weight ratio of fiber to protein of at least 5 to 1.

14. The method of claim 11, further comprising heating the contents of the tray after the step of removing the cover and before the step of presenting the tray to the dog.

15. The method of claim 11, further comprising conditioning the dog to respond to the dog treat.

16. The method of claim 11, further comprising adhering the tray to a floor before or during the step of presenting the tray to the dog.

17. The method of claim 11, wherein the main course has a protein content of at least 30% by weight.

18. The method of claim 17, wherein the tray includes a third separate compartment, the method further including selecting a side dish and placing a desired amount of the side dish into the third compartment, the dog consuming at least a portion of the side dish.

19. The method of claim 18, wherein the side dish selected has a weight ratio of fiber to protein of at least 5 to 1.

20. The method of claim 19, wherein the dog treat selected includes a flavor-enhancing additive.
